(19) United States
(12) Patent Application Publication
(10) Pub. No.: US 2003/0159840 A1
(43) Pub. Date: Aug. 28, 2003

(54) Power groomer for snow & earth terrain

(76) Inventor: Anthony Schmidt JR., West Branch, MI (US)

Correspondence Address: RICHARD S. ROSS, ESQ., 4801 S UNIVERSITY DR., 3070, FT. LAUDERDALE, FL, 33328, US

(21) Appl. No.: 10/085,892

(22) Filed: Feb. 28, 2002

(51) Int. Cl. A01B 49/02

(52) U.S. Cl. 172/145; 172/540

(57) ABSTRACT

An improved trail groomer apparatus having multiple components arranged in an integrated ensemble is herein disclosed. The preferred embodiments of this trail groomer comprises a rectilinear frame having, arranged in series, a power tiller, a pulverizer assembly and a compacting roller. These functional components turn over the irregular and often hard packed surface of snow and ice, or earth, grind or pulverize it into a fine powder or granule material and thereafter compact it into a smooth, rut-free trail.

### BACKGROUND OF THE INVENTION

1. Field of the Invention

This invention relates to an article of manufacture. More specifically, this invention is directed to an improvement in a power groomer for snow trails and earth terrain.

2. Background of Invention

Rotary tillers have been used in the past to maintain cross country ski trails. Such tillers are normally provided with a rotatable tiller shaft having an array of radial cutters. These radial cutters are traditionally aligned perpendicular to the direction of travel of the towing vehicle. To simplify the maintenance of the cross country ski trails, and also to make it cheaper, the tiller ensemble can be built wide enough so that it covers two adjoining cross country ski tracks together with the associated pole tracks. The ensemble thus extends altogether over two pairs of cross country ski tracks and a total of four adjacent pole tracks, which respectively run parallel to the cross country tracks. The cutters of the tiller shaft all have a uniform length.

The known rotary tiller has proven itself to be both effective and efficient in the grooming of cross country ski trails. In one application, it can create or again refurbish both the cross country ski trail which leads to the destination as well as the return trail. In the case of refurbishing the trail, the tiller tills the existing trail by comminuting the snow down to a certain depth and mixing the upper layer with the lower layer. A trailing roller or compactor unit then impresses the cross country ski trail into the freshly prepared snow, so as to provide a freshly groomed path, and otherwise to inhibit the freshly comminuted snow and ice power from being displaced by the wind. The following patents are representative of the snow grooming equipment in use today:

U.S. Pat. No. 3,794,122 (to Rohrer, issued Feb. 26, 1974) discloses a snow conditioning machine for grooming snow trails with hard packed snow. The Rohrer device includes means from breaking up hard pack snow (Ref No. 60) and feeding it into a grinder for comminuting and pulverizing the chucks of ice and hard packed snow. Once the snow and ice chucks are pulverized, a trailing roller compacts the comminuted powder.

U.S. Pat. No. 4,056,328 (to Maxey, issued Nov. 1, 1977) discloses an apparatus for grooming snowmobile trails designed to be towed by a tracked vehicle. In brief, this apparatus includes a generally horizontal main frame, a gooseneck hitch supporting the forward end of the frame in towing engagement with the tracked vehicle, (a) a packing roller supporting the rear end of the frame which serves to pack the snow being groomed, (b) a moldboard scraper mounted between the packing roller, which serves to scrape and level the snow being groomed, and (c) a cutting blade assembly mounted forwardly of the moldboard scraper cuts, breaks and moves snow to fill in grooves and level ridges. A floating pan secured to the rear end of the main frame smooths the snow following packing by the roller.

The snow breaking and cutting blade assembly includes a pair of opposed, spaced-apart cutting blades pivotally secured to the frame and inclined inwardly and rearwardly, and a central V-shaped cutting blade pivotally secured to the frame with the apex thereof directed forwardly. The inner free ends of the inclined blades and the apex of the V-shaped blade are coordinated for raising and lowering to cause the apex of the V-shaped blade to swing oppositely to the free ends of the inclined blades for purposes of controlling the flow of snow through the frame to the moldboard scraper and packing roller.

Other representative patent references, which disclose alternative configurations for grooming ski trails, include U.S. Pat. Nos. 4,163,329 and 4,520,582.

All of the foregoing patents describe grooming assemblies that are deficient in one or more respects relative to the effectiveness and efficiency in design and operation. Accordingly there continues to exist a need for improvement in a snow and earth grooming apparatus, specifically, in comminuting the chucks of pack snow and ice, or earth, necessary to restore the trail to virgin condition.

### OBJECTS OF THE INVENTION

It is the object of this invention to remedy the above and related deficiencies in the prior art.

More specifically, its is the principal object of this invention to provide an improved trail groomer ensemble having a power tiller and multiple pulverizer means for converting packed snow and ice, or packed earth, into fine powder and granules, and thereafter redistribution thereof as a groomed trail.

It is another object of this invention to provide an improved trail groomer ensemble having a hydraulically operated compacting roller for impressing the freshly prepared terrain into a groomer trail or path, where the roller can act as a vehicle tire to facilitate the movement of the groomer when not in use.

Additional objects include a method for preparation of a groomed trail utilizing the improved trail groomer ensemble of this invention

### SUMMARY OF THE PRESENT INVENTION

The above and related objects are achieved by providing an improved trail groomer having multiple components arranged in an integrated ensemble for grooming a trail or path for recreational use (skiing, snow boarding, all-terrain vehicle riding, horseback riding, etc.). In the preferred embodiments of this invention, the trail groomer ensemble comprises a rectilinear frame having arranged, in processing series or sequence, a power tiller, a pulverizer assembly and a compacting roller. These functional components turn over the irregular and often hard packed surface of snow and ice, or hardened earth, grind or pulverize it into a fine powder or granule and thereafter compact it into a smooth, rut-free trail. The housing, in which these functionally distinct and independent components are contained and supported, includes not only means for positioning and supporting these distinct processing stations, but also means for power coupling of the tiller to an external drive shaft of a towing tractor or mule, and means for containment or channeling the chunks of hard packed terrain from the tiller, within the confines of the groomer, so as to insure its grinding by the pulverizer assembly and thereafter compaction by the roller. This containment means is formed from a relatively coarse brush-like material, so as to provide the requisite containment of the comminuted terrain within the groomer throughout its processing and yet is sufficiently forgiving and compliant so as to conform to the irregular terrain.

In another of the preferred embodiments of this invention, the power tiller is mounted within the housing at an angle which is off-set from a normal angle (perpendicular or 90 degrees) to the direction of travel of the groomer assembly to provide enhanced comminuting action.

### BRIEF DESCRIPTION OF DRAWINGS

FIG. 1 is a perspective view of the improved trail groomer of this invention.

FIG. 2 is a perspective view of the improved trail groomer of FIG. 1 when viewed from below.

FIG. 3 is a bottom view of the improved trail groomer of FIG. 2.

FIG. 4 is a sectional view of the improved trail groomer of FIG. 3 at line 4-4.

### DETAILED DESCRIPTION OF THE INVENTION INCLUDING PREFERRED EMBODIMENTS

The figures which accompany this application, and which are referenced herein, depict a representative groomer assembly of this invention. In the embodiments of this invention illustrated in these figures, one or more components of the groomer assembly may appear in more than one figure. Accordingly, components which are common to more than one figure are assigned a common reference numeral for continuity of description and ease of understanding. For simplicity of description and understanding, the invention is described in reference to a grooming assembly for snow trails. It is, however, understood that the instant assembly can be adapted for grooming earthen riding trails, or agricultural applications.

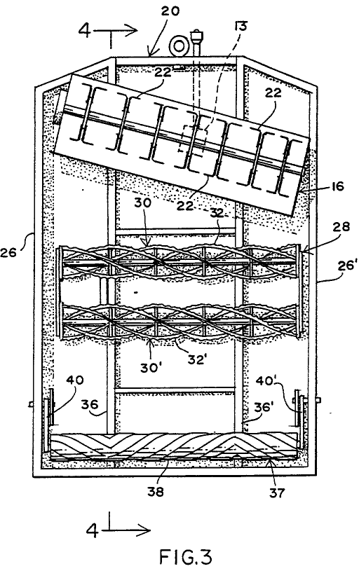

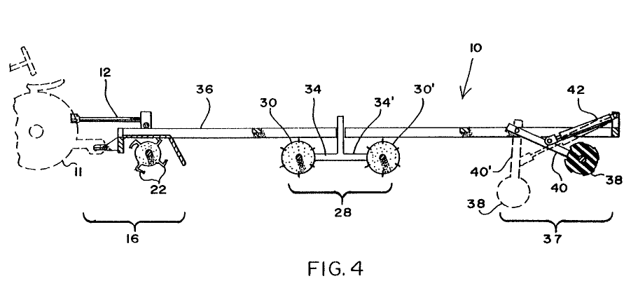

FIG. 1 shows the groomer assembly (10) in tow. The towing vehicle (11) can be any conveyance suitable for the terrain being groomed, and which is provided with a take-off drive mechanism to power a shaft (12) connected to the gear box (13), (illustrated in FIG. 3) of the tiller mechanism (16) of the assembly (10). In the illustration shown in FIG. 1, the groomer (10) is being drawn from left to right along a ski trail. In this illustration, the groomer assembly (10) is depicted as having a housing (14) comprising an essentially rectangular compartment with an opening (20) in the forward end of the housing (14) proximate to the towing vehicle.

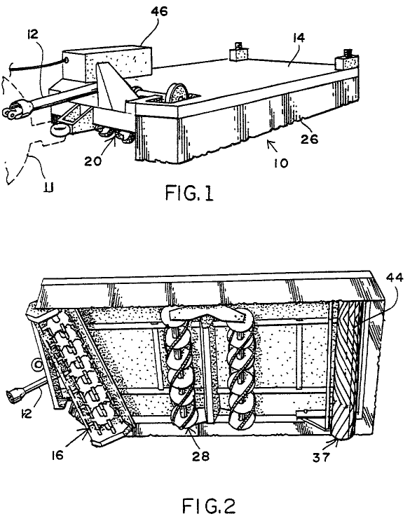

The interior features of the groomer assembly are illustrated in FIGS. 2, 3 & 4. Immediately interior to this forward opening (20) in the housing (14) of the groomer housing is a tiller assembly (16). This tiller assembly (16) is positioned to comminute the hard packed snow and ice along the path of the towing vehicle. The rotating tines (22) of the tiller (16) are positioned so as to penetrate the compacted snow and ice to a depth of anywhere from two (2) to six (6) inches. The depth of penetration is set by movement of an elevator means (not shown), which can be power operated or manually activated. The speed of rotation of the tines (22) on the tiller (16) is controlled independent of the speed of the towing vehicle by a gear box (13) and can be adjusted to the condition of the terrain. The power shaft (12) from the towing vehicle (11) transfers power through this gear box (transmission) (13) of the groomer housing (14) to the tiller (16) within the housing (14).

In the preferred embodiments of this invention, the tiller (16) is positioned within the housing (14) at an angle which is off-set from a normal angle (perpendicular or 90 degrees) up to 25 degrees, and most preferable about 15 to 18 degrees, from the direction of movement of the groomer assembly over the terrain. The off-setting of the tiller (16) in this manner substantially enhances both the efficiency and effectiveness of the tiller (16) in comminuting the hard packed snow and ice, preliminary to pulverizing it by the next processing station with the groomer (10).

The comminuted hard pack snow and ice is retained within the housing (14) of the groomer by a skirt (24) which is attached to each of the lateral structural supports (26, 26′) of the housing. This skirt (24) is comprised of a resilient material, such as brush-like bristles, to both contain the comminuted hard pack snow and ice within the groomer housing (14) following its initial processing by the power tiller (16), and also to channel the comminuted hard pack snow and ice into the pulverizer assembly (28).

As shown in FIGS. 2, 3 & 4, the pulverizer assembly (28) includes a pair of cylinders (30, 30′) having an ordered array of blades or cutters (32, 32′) projecting from the cylinder surface. Each of these blades is mounted upon the surface of each of these cylinders at an angle which is off-set from a normal angle (surface of each of these cylinders) up to 20 degrees, and most preferable about 15 degrees, from the direction of movement of the groomer assembly over the terrain.

Each cylinder (30, 30′) is connected on its end, through its hub, to an articulating arm (34, 34′), and each such arm, in turn pivotally mounted to and supported from a rail (36, 36′) that is integral with the housing frame. In the embodiments of this invention, each of these cylinders (30, 30′) is positioned at about or somewhat below the desired height of the grade of the groomed trail. As the groomer assembly (10) is drawn by the towing vehicle (11) over the trail, the comminuted hard packed snow and ice, from the power tiller (16), comes in contact with, and passes under each of these pulverizer cylinders (30, 30′). The blades (32, 32′) from each of these cylinders (30, 30′) further reduce the comminuted hard packed snow and ice to a fine powder or granule. In addition, each of these pulverizers functions to level/distribute the comminuted hard pack snow and ice along the path of travel of the groomer assembly, so as to fill in any ruts or holes in the trail.

After the snow is pulverized, it is then compacted by a roller assembly (37) illustrated in FIGS. 2, 3 & 4. This roller assembly (37) comprises a rubber or rubberized cylinder (38) that is mounted through its hub to a pair of hydraulically actuated arms (40, 40′). The relative height of these arms (40, 40′) is controlled by a telescoping piston (42, 42′) mounted to the frame of the groomer compartment; and, which can be power or manually controlled by the groomer operator, to increase or decrease the extension of the roller from the frame of the groomer housing and thereby the height and resultant pressure of the pulverizer assembly upon the comminuted snow and ice. In one of the preferred embodiments of this invention, the pistons (42, 42′) are actuated by a hydraulic pump (46) situated upon the roof of the housing (14).

In the embodiment of this invention illustrated in FIG. 2, the roller surface (44) is patterned so as create an embossed pattern on the surface of the snow incident to the compaction process. This pattern provides the trail with indicia identifying it as a designated trail and safe, and is used, in combination with poles or flags, to protect the skier from going off the trail. This compacting roller assembly (37) can be weighted by addition of ballast to the roller cylinder, or alternatively, by simply adding weight onto the exterior housing above the roller assembly (37).

The invention as above described is provided as illustrative of a number of the preferred embodiments of this invention. In the embodiments shown herein, the focus of the discussion has been the groomer of ski trails. Notwithstanding, the multiple stations within the groomer assembly can be modified within the spirit and scope of this invention to adapt to the dressing and grooming of various terrains, including riding trails, beaches, and construction sites. Thus, this description is neither intended nor should it be construed to delineate the scope of this invention, which has been reserved for the claims that follow.

What is claimed is:

1. In an apparatus for grooming terrain having an irregular or compacted surface, wherein said apparatus includes means for sequentially comminuting said terrain surface and thereafter compacting said comminuted materials from said terrain surface, wherein the improvement comprises:
A. Means for comminuting an irregular or compact surface of terrain comprising a power activated tiller, said tiller comprising a cylinder having an array of tines projecting from its surface, means for transmission of power from a gear box to said tiller and means for off-setting of said tiller at an angle of up to about 25 degrees relative to the direction of travel of said groomer;
B. Means for pulverizing said comminuted terrain into a substantially granular material of essentially uniform size; and
C. Means for compacting said substantially granular material into a groomed trail.

2. The improved groomer assembly of claim 1, wherein said tiller is aligned at an angle of about 15 to 18 degrees relative to the direction of travel of said groomer.

3. The improved groomer assembly of claim 1, wherein said tiller is rotated at a speed independent of the relative movement over said terrain.

4. The improved groomer assembly of claim 1, wherein said tiller penetrates and comminutes said terrain to a depth of from about 2 to 6 inches below the surface of said terrain.

5. The improved groomer assembly of claim 1, wherein said groomer includes means for containment and arrangement of each said tiller, pulverizer and compacting means within a common housing, said housing comprising a rectilinear compartment having a frame, from which each of each said tiller, pulverizer and compacting means is attached and supported.

6. The improved groomer assembly of claim 5, wherein said housing includes means for channeling said comminuted terrain from said tiller to said pulverizer, said containment/channeling means comprising resilient bristles attached to each lateral member of said frame.

7. The improved groomer assembly of claim 5, wherein said pulverizing means includes an ordered array of blades or cutters projecting from the surface of said pulverizer roller, said blades being mounted upon the surface of each of these cylinders at an angle which is off-set from a normal angle up to 20 degrees, and most preferable about 15 degrees from said surface.

8. The improved groomer assembly of claim 1, wherein said means for compaction of said comminuted substantially granular material includes means for extension and retraction of a roller relative to said pulverizer means.

9. The improved groomer assembly of claim 8, wherein said compaction means includes a roller having a patterned surface for embossing said groomed trail, and thereby providing for identification of said terrain as a groomed trail.

10. The improved groomer assembly of claim 8, wherein said compaction means includes at least one ballast.

11. In an apparatus for grooming terrain having an irregular or compacted surface, wherein said apparatus includes means for sequentially comminuting said terrain surface and thereafter compacting said comminuted materials from said terrain surface, wherein the improvement comprises:
A. Means for comminuting an irregular or compact surface of terrain comprising a power activated tiller, said tiller comprising a cylinder having an array of tines projecting from its surface, means for transmission of power from a gear box to said tiller and means for off-setting of said tiller at an angle of up to about 25 degrees relative to the direction of travel of said groomer;
B. Power transmission means for connecting said tiller through a drive shaft to a towing vehicle, said power transmission means including a gear box for controlling the speed of said tiller independent of the speed of said towing vehicle;
C. Means for pulverizing said comminuted terrain into a substantially granular material of essentially uniform size; and
D. Means for compacting said substantially granular material into a groomed trail.
